(19) United States
(12) Patent Application Publication
(10) Pub. No.: US 2012/0225771 A1
(43) Pub. Date: Sep. 6, 2012

(54) METHOD FOR PRODUCING CATALYST-SUPPORTING CARRIER AND APPARATUS FOR PRODUCING SAME

(76) Inventors: Hideyuki Miyazawa, Kanagawa (JP); Hiroshi Kondo, Kanagawa (JP); Shogo Suzuki, Kanagawa (JP); Shozo Murata, Kanagawa (JP); Noriaki Okada, Kanagawa (JP); Aya Utsuki, Kanagawa (JP)

(21) Appl. No.: 13/508,067

(22) PCT Filed: Oct. 25, 2010
(86) PCT No.: PCT/JP10/69241

§ 371 Date: May 4, 2012

(30) Foreign Application Priority Data
Nov. 11, 2009 (JP) 2009-258346
Sep. 3, 2010 (JP) 2010-198130

(51) Int. Cl. B01J 31/02; B01J 31/22; B01J 19/00; B01J 37/16; B01J 23/44

(52) U.S. Cl. 502/171; 502/100; 502/339; 422/187

(57) ABSTRACT

Disclosed is a method for producing a catalyst-supporting carrier, including a step of supplying subcritical carbon dioxide or supercritical carbon dioxide to a dissolving tank containing a catalyst precursor generated when a catalyst is reduced to dissolve the catalyst precursor in the subcritical carbon dioxide or the supercritical carbon dioxide; a step of supplying the subcritical carbon dioxide or the supercritical carbon dioxide in which the catalyst precursor is dissolved to a supporting tank containing a carrier and reducing the catalyst precursor to cause the catalyst to be supported on the carrier; and a step of supplying the sub-critical carbon dioxide or the supercritical carbon dioxide to the supporting tank containing the carrier on which the catalyst is supported to clean the carrier.

### TECHNICAL FIELD

The present invention relates to a method for producing a catalyst-supporting carrier and an apparatus for producing the catalyst-supporting carrier.

### BACKGROUND ART

Catalysts have become widespread in various industrial fields. Among them, catalysts for purifying exhaust gases from automobiles, catalysts for fuel cells, ammonia synthesizing catalysts for a Haber-Bosh process, hydrogeneration catalysts, photocatalysts, etc., have been known. Based on the fact that the catalysts react on a front surface, methods for producing catalyst fine particles to enhance catalyst activity have been known.

Patent Document 1 discloses a method for producing a catalyst-supporting carrier in which catalyst fine particles are supported in the pores of a porous substrate where the pores have an average pore size of 3.4 nm or less and a standard deviation of 0.2 nm or less. The method includes a fluid intrusion step in which the precursors of the catalyst fine particles are dissolved in a supercritical fluid and the precursor-dissolved fluid is brought into contact with the porous substrate so as to make the supercritical fluid intrude into the pores to arrange the precursors inside the pores. In addition, the method applies a reduction treatment to the porous substrate in which the precursors are arranged inside the pores.

However, this method has difficulty in controlling the particle size of the catalyst fine particles.

Patent Document 1: JP-A-2004-283770

### DISCLOSURE OF INVENTION

The present invention has been made in view of the above problem and may provide a method for producing a catalyst-supporting carrier capable of controlling the particle size of a catalyst and an apparatus for producing the catalyst-supporting carrier.

According to an aspect of the present invention, there is provided a method for producing a catalyst-supporting carrier, including a step of supplying subcritical carbon dioxide or supercritical carbon dioxide to a dissolving tank containing a catalyst precursor generated when a catalyst is reduced to dissolve the catalyst precursor in the subcritical carbon dioxide or the supercritical carbon dioxide; a step of supplying the subcritical carbon dioxide or the supercritical carbon dioxide in which the catalyst precursor is dissolved to a supporting tank containing a carrier and reducing the catalyst precursor to cause the catalyst to be supported on the carrier; and a step of supplying the subcritical carbon dioxide or the supercritical carbon dioxide to the supporting tank containing the carrier on which the catalyst is supported to clean the carrier.

According to another aspect of the present invention, there is provided an apparatus for producing a catalyst-supporting carrier, including a dissolving tank in which a catalyst precursor generated when a catalyst is reduced is dissolved in subcritical carbon dioxide or supercritical carbon dioxide; a supplying unit that supplies the subcritical carbon dioxide or the supercritical carbon dioxide to the dissolving tank; a supporting tank in which the catalyst precursor dissolved in the subcritical carbon dioxide or the supercritical carbon dioxide is reduced to cause the catalyst to be supported on a carrier; and a cleaning unit that supplies the subcritical carbon dioxide or the supercritical carbon dioxide to the supporting tank to clean the carrier on which the catalyst is supported.

### BRIEF DESCRIPTION OF DRAWINGS

FIG. 1 shows an example of an apparatus for producing a catalyst-supporting carrier according to an embodiment of the present invention;

FIG. 2 is a diagram showing the three states of carbon dioxide;

FIG. 3 is a perspective view showing an example of a honeycomb structure;

FIG. 4 is a perspective view showing a modification of the honeycomb structure;

FIG. 5 is an SEM photograph of a Pd-particles-supporting carrier according to Example 1;

FIG. 6 is an SEM photograph of the Pd-particles-supporting carrier according to Example 4; and

FIG. 7 is an SEM photograph of the Pd-particles-supporting carrier according to Example 6.

### BEST MODE FOR CARRYING OUT THE INVENTION

Next, a description is made of a mode for carrying out an embodiment of the present invention with reference to the accompanying drawings.

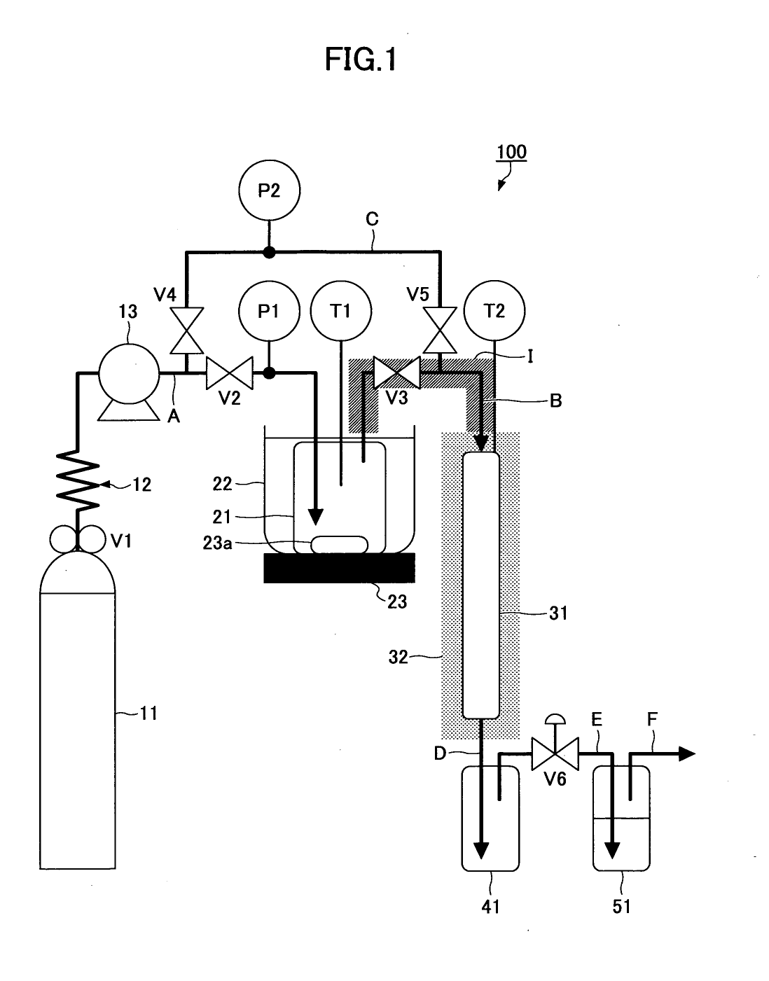

FIG. 1 shows an example of an apparatus for producing a catalyst-supporting carrier according to the embodiment of the present invention. The apparatus 100 for producing the catalyst-supporting carrier has a cylinder 11 that supplies carbon dioxide; a dissolving tank 21 in which catalyst precursors generated when a catalyst is reduced are dissolved in subcritical carbon dioxide or supercritical carbon dioxide; a supporting tank 31 in which the catalyst is supported on a carrier; a solid-gas separator 41; and a gas-liquid separator 51.

A pipe A that connects the cylinder 11 to the dissolving tank 21 has a pressure reduction valve V1,a cooler 12, a high-pressure pump 13, a stop valve V2, and a pressure sensor P1 serially provided from its upstream side. Further, a pipe B that connects the dissolving tank 21 to the supporting tank 31 has a stop valve V3 and is covered with a thermal insulating material I at its periphery. Moreover, a bypass pipe C that connects the pipe A to the pipe B is provided, and the bypass pipe C has a stop valve V4, a pressure sensor P2, and a stop valve V5 from its upstream side. Note that the bypass pipe C is connected between the high-pressure pump 13 and the stop valve V2 each provided in the pipe A and between the stop valve V3 provided in the pipe B and the supporting tank 31. Further, a pipe E that connects the solid-gas separator 41 to the gas-liquid separator 51 has a back-pressure valve V6. Thus, a pressure inside a system can be controlled by the pressure sensors P1 and P2, the high-pressure pump 13, and the back-pressure valve V6.

The pressure sensors P1 and P2 are not particularly limited, but include AP-16S (manufactured by KEYENCE CORPORATION), or the like.

The dissolving tank 21 has a temperature sensor T1 that detects an internal temperature and is arranged inside a constant-temperature tank 22. Thus, a temperature inside the dissolving tank 21 can be controlled by the temperature sensor T1 and the constant-temperature tank 22. Further, a magnetic stirrer 23 and a stirring bar 23a that stir contents inside the dissolving tank 21 are provided. The supporting tank 31 has a temperature sensor T2 that detects an internal temperature and is arranged inside a heater 32. Thus, the temperature inside the supporting tank 31 can be controlled by the temperature sensor T2 and the heater 32.

The temperature sensors T1 and T2 are not particularly limited, but include a thermocouple, a resistance thermometer, or the like.

Next, a description is made of a method for producing the catalyst-supporting carrier by the apparatus 100 for producing the catalyst-supporting carrier.

First, in a state in which the pressure-reduction valve V1, the stop valves V2, V3, V4, and V5, and the back-pressure valve V6 are closed and the high-pressure pump 13 is stopped, (excessive amounts of) catalyst precursors and a carrier are placed into the dissolving tank 21 and the supporting tank 31, respectively. Then, the pressure-reduction valve V1, the stop valves V2, V3, V4, and V5, and the back-pressure valve V6 are opened so that air inside the system is replaced with carbon dioxide and rises to a prescribed pressure. After that, the pressure-reduction valve V1 and the stop valves V2, V3, V4, and V5 are closed. Moreover, the temperatures inside the dissolving tank 21 and the supporting tank 31 are respectively raised by the constant-temperature tank 22 and the heater 32 to a temperature equal to or higher than the critical temperature of carbon dioxide and a temperature at which the catalyst precursors can be reduced. After that, the stop valves V4 and V5 are opened and the high-pressure pump 13 is operated so that the system excluding a part between the stop valves V2 and V3 is raised to a pressure equal to or greater than the critical pressure of carbon dioxide. Next, after the stop valves V4 and V5 are closed, the stop valves V2 and V3 are opened so that the part between the stop valves V2 and V3 is raised to the same pressure as that of the system excluding the stop valves V2 and V3 to supply supercritical carbon dioxide to the dissolving tank 21. At this time, the stirring bar 23a is rotated by the magnetic stirrer 23 so that the catalyst precursors are dissolved in the supercritical carbon dioxide. Then, the catalyst precursors dissolved in the supercritical carbon dioxide are supplied by the high-pressure pump 13 to the supporting tank 31 for a predetermined time. At this time, since the supercritical carbon dioxide is supplied to the dissolving tank 21, undissolved catalyst precursors can be further dissolved. The catalyst precursors supplied to the supporting tank 31 are thermally reduced to generate a catalyst cluster, i.e., a catalyst. The catalyst is supported on the carrier. Thus, the catalyst-supporting carrier is obtained. At this time, the catalyst not supported on the carrier is not dissolved in the supercritical carbon dioxide but is discharged from the supporting tank 31 and stored in the solid-gas separator 41. Further, after being dissolved in the supercritical carbon dioxide and discharged from the supporting tank 31, unreacted catalyst precursors and by-products are discharged from the back-pressure valve V6 via the solid-gas separator 41 and stored in the gas-liquid separator 51. Moreover, after being discharged from back-pressure valve V6, the supercritical carbon dioxide is evaporated and discharged from the gas-liquid separator 51.

Then, after the stop valves V2 and V3 are closed, the stop valves V4 and V5 are opened to supply the supercritical carbon dioxide to the supporting tank 31. Thus, the unreacted catalyst precursors and the by-products attached to the catalyst supporting carrier are removed.

At this time, the particle size of the catalyst can be controlled by controlling a speed at which the catalyst precursors are supplied to the supporting tank 31, a speed at which the catalyst precursors are thermally reduced in the supporting tank 31, and a time in which the catalyst precursors are accumulated in the supporting tank 31.

Specifically, the dissolving amount of the catalyst precursors in the supercritical carbon dioxide is changed by changing the temperature inside the dissolving tank 21, the pressure inside the system, and the time in which the catalyst precursors are dissolved. Thus, the speed at which the catalyst precursors are supplied to the supporting tank 31 can be controlled by changing the dissolving amount of the catalyst precursors in the supercritical carbon dioxide and the speed at which the catalyst precursors dissolved in the supercritical carbon dioxide are supplied to the supporting tank 31.

A method for measuring the dissolving amount of the catalyst precursors in the supercritical carbon dioxide is not particularly limited, but includes a direct method in which the mass of the catalyst precursors dissolved in the supercritical carbon dioxide is measured by a flow method, an indirect method in which the mass of the catalyst precursors dissolved in the supercritical carbon dioxide is measured by an ultraviolet visible absorption method, or the like.

Further, the speed at which the catalyst precursors are thermally reduced in the supporting tank 31 can be controlled by changing the temperature inside the supporting tank 31 and the pressure inside the system.

Moreover, the time in which the catalyst precursors are accumulated in the supporting tank 31 can be controlled by changing the pressure inside the system.

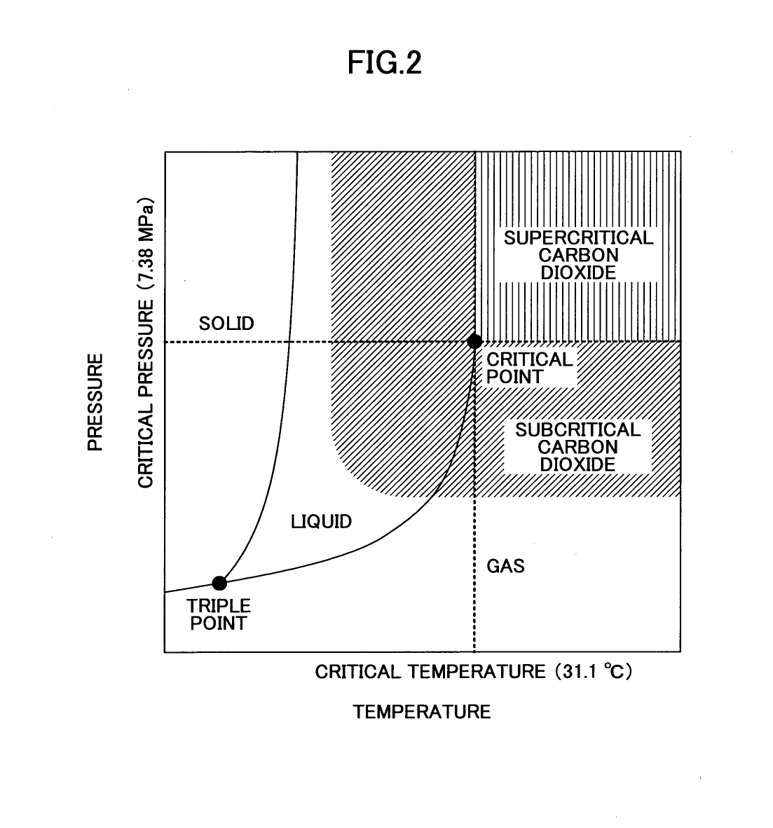

As shown in FIG. 2, the supercritical carbon dioxide has a temperature higher than or equal to a critical temperature and has a pressure greater than or equal to a critical pressure. Further, as shown in FIG. 2, the subcritical carbon dioxide is carbon dioxide having a temperature and/or a pressure slightly smaller than those of the supercritical carbon dioxide.

Note that carbon dioxide has a critical temperature of 31.1° C. and a critical pressure of 7.38 MPa, which are lower than those of other fluids. Further, with the supercritical carbon dioxide, organic compounds show moderate solubility. Moreover, the supercritical carbon dioxide is evaporated and diffused at normal temperature and normal pressure, i.e., under atmospheric pressure. Therefore, the supercritical carbon dioxide enables easy separation of products and reduces an impact on the environment, which in turn ensures high security.

Table 1 shows typical characteristic values of gas, supercritical fluid, and liquid.

TABLE 1

| | | SUPERCRITICAL | |
|---|---|---|---|
| | GAS | FLUID | LIQUID |
| DENSITY | 0.6 TO 1 | 200 TO 900 | 1 × 10³ |
| [kg/m³] | | | |
| VISCOSITY | 1 × 10⁻⁵ | 1 × 10⁻⁵ TO | 1 × 10⁻³ |
| [Pa · sec] | | 1 × 10⁻⁴ | |
| DIFFUSION | 1 × 10⁻⁵ | 1 × 10⁻⁷ TO | <1 × 10⁻⁹ |
| COEFFICIENT | | 1 × 10⁻⁸ | |
| [m²/sec] | | | |

Note that the characteristics of the supercritical fluid, such as density, viscosity, and permittivity can be changed by changing the temperature and the pressure of a reaction system.

The catalyst precursors are not particularly limited so long as they are dissolved in the supercritical carbon dioxide and capable of being generated when a catalyst is reduced, but include a metal complex; metal salt such as metal amide and metal alkoxide; or the like, and they may be used in combination. Among them, a metal complex or metal alkoxide is preferable since it is soluble in the supercritical carbon dioxide.

The catalyst is not particular limited, but includes gold, copper, silver, platinum, iron, palladium, ruthenium, rhodium, tungsten, nickel, tantalum, bismuth, tin, zinc, titanium, aluminum, manganese, cobalt, iridium, osmium, molybdenum, chromium, vanadium, or the like, and they may be used in combination.

The ligand of the metal complex is not particularly limited, but includes acetyl acetonato, hexafluoro acetyl acetonato, 2,2,6,6-tetramethyl-3,5-heptanedionato, trimethyl octanedionate, triethyl octanedionate, vinyl trimethylsilane, cyclopendadiene, or the like.

A specific example of the metal alkoxide includes Mg (OC₂H₅)₂, Mo(OC₂H₅)₅, Ba(OC₂H₅)₂, Zn(OC₂H₅)₂, Cu(OCH₃)₂, Cu(OC₂H₅)₂, Cu(OC₃)₃, or the like.

A specific example of the metal complex includes bis(acetylacetonato)palladium(II), bis(2,2,6,6-tetramethyl-3,5-heptanedionato)palladium(II), bis(hexafluoroacetylacetonato)palladium(II), bis(cyclopentadienyl)palladium(II), or the like.

The carrier is not particularly limited so long as it is not dissolved in the supercritical carbon dioxide, but includes alloys such as stainless steel and nickel alloy; ceramics such as alumina mullite, cordierite, and silica; polymer; or the like. Among them, titanium or titanium alloy is preferable.

The shape of the carrier is not particularly limited so long as it has a porous shape, but is preferably a honeycomb structure. The honeycomb structure can increase a contact area between the fluid and the catalyst and sufficiently provide the effect of the catalyst. In addition, compared with a sponge-shaped structure capable of increasing the contact area, the honeycomb structure can reduce the pressure loss of the fluid.

The honeycomb structure is generally of a cylindrical shape having a diameter in the range of several cm through several tens of cm and a length in the range of several tens of cm through several m. Further, the size of the opening part of the honeycomb structure is generally in the range of several tens of μm through several cm.

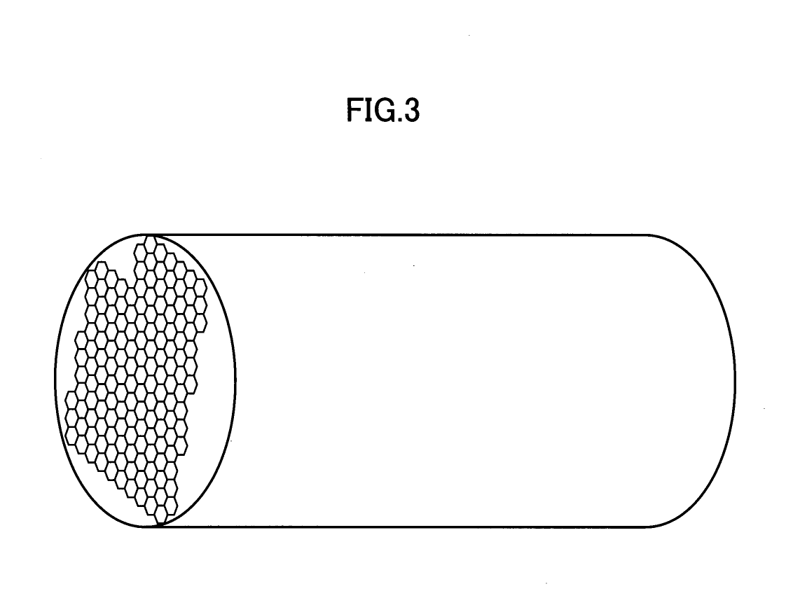

The cross-sectional shape of the opening part of the honeycomb structure is not particularly limited, but is preferably a cylindrical shape, a hexagonal shape (see FIG. 3), a rectangular shape, a triangular shape, or the like. Among them, the hexagonal shape is preferable.

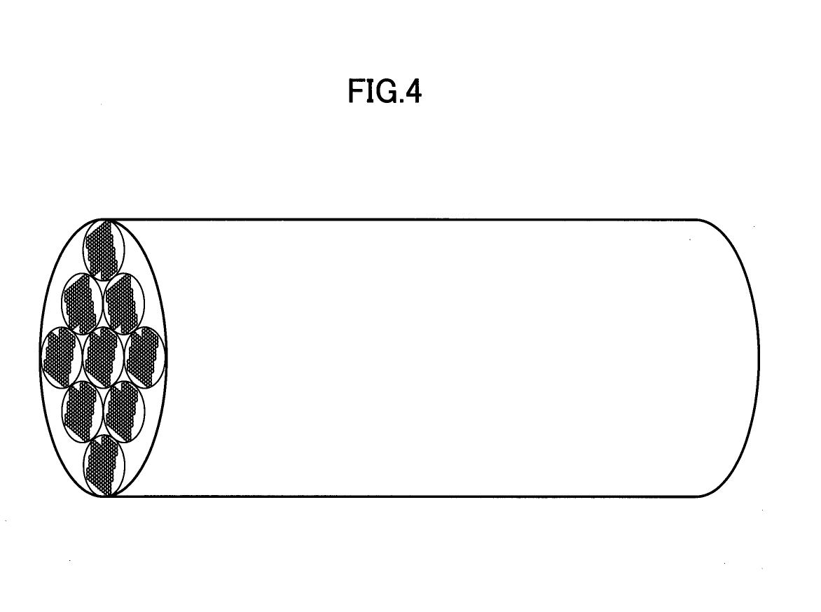

Note that the honeycomb structure may be configured to have plural honeycomb structures bundled with each other as shown in FIG. 4.

When the catalyst is supported on the porous carrier, the catalyst precursors dissolved in the supercritical carbon dioxide can be sufficiently supplied to the inside of the carrier because the diffusion coefficient of the supercritical carbon dioxide is large as shown in table 1. Thus, the catalyst can be uniformly supported on the porous carrier.

The catalyst-supporting carrier produced in the above manner can be applied to catalysts for purifying exhaust gases from automobiles, catalysts for fuel cells, ammonia synthesizing catalysts for a Haber-Bosh process, hydrogeneration catalysts, photocatalysts, etc.

Note that the subcritical carbon dioxide may be used instead of the supercritical carbon dioxide in accordance with the solubility of the catalyst precursors.

Further, instead of being thermally reduced, the catalyst precursors may be reduced by energy such as light and ultrasonic waves. In this case, however, it is necessary to irradiate the inside of the supporting tank 31 with light or apply ultrasonic vibrations to the inside of the supporting tank 31. Further, the catalyst precursors may be reduced by a reducing agent, but an unreacted reducing agent could adversely affect the characteristics of the catalyst.

Moreover, the catalyst supported on the catalyst-supporting carrier may be oxidized by a method for circulating highly-purified air, or the like.

Further, instead of providing the bypass pipe C, the supercritical carbon dioxide may be supplied to the supporting tank 31 to clean the catalyst-supporting carrier. In this case, a cylinder and the supporting tank 31 are connected to each other so that a pipe having a pressure-reduction valve, a cooler, a high-pressure pump, a pressure sensor, and a stop valve serially provided from its upstream side can be provided.

### EXAMPLES

### Example 1

Using the apparatus 100 for producing the catalyst-supporting carrier shown in FIG. 1, a Pd-particles-supporting carrier was produced. Specifically, first, in a state in which the pressure-reduction valve V1, the stop valves V2, V3, V4, and V5, and the back-pressure valve V6 were closed and the high-pressure pump 13 was stopped, 1 g of Pd(acac)₂ and 5 g of a honeycomb-shaped carrier were placed into the dissolving tank 21 having a volume of 50 mL and the supporting tank 31 having a volume of 50 mL. Then, the pressure-reduction valve V1, the stop valves V2, V3, V4, and V5, and the back-pressure valve V6 were opened so that air inside the system was replaced with carbon dioxide of which the pressure was reduced to 0.5 MPa and raised to the pressure of the cylinder 11. After that, the pressure-reduction valve V1 and the stop valves V2, V3, V4, and V5 were closed. Moreover, the temperatures inside the dissolving tank 21 and the supporting tank 31 were respectively raised by the constant-temperature tank 22 and the heater 32 to 60° C. and 350° C. After that, the stop valves V4 and V5 were opened and the high-pressure pump 13 was operated so that the system excluding the part between the stop valves V2 and V3 was raised to 20 MPa. Next, after the stop valves V4 and V5 were closed, the stop valves V2 and V3 were opened so that the part between the stop valves V2 and V3 was raised to 20 MPa to supply the supercritical carbon dioxide to the dissolving tank 21. At this time, the stirring bar 23a was rotated by the magnetic stirrer 23 so that the Pd(acac)₂ was dissolved in the supercritical carbon dioxide. Then, the Pd(acac)₂ dissolved in the supercritical carbon dioxide was supplied by the high-pressure pump 13 to the supporting tank 31 for two hours to obtain the Pd-particles-supporting carrier.

Then, after the stop valves V2 and V3 were closed, the stop valves V4 and V5 were opened to supply the supercritical carbon dioxide to the supporting tank 31. After being cleaned, the Pd-particles-supporting carrier was collected from the supporting tank 31.

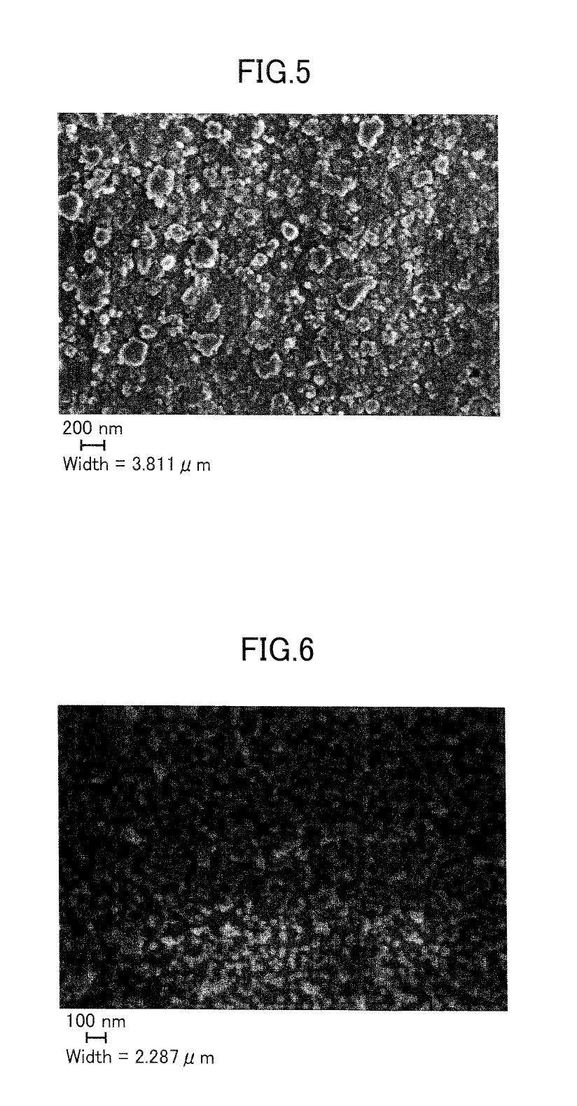

FIG. 5 shows an SEM photograph of the Pd-particles-supporting carrier.

### Example 2

Other than changing the temperature inside the dissolving tank 21 to 40° C., the Pd-particles-supporting carrier was obtained in the same manner as Example 1.

### Example 3

Other than changing the temperature inside the dissolving tank 21 to 80° C., the Pd-particles-supporting carrier was obtained in the same manner as Example 1.

### Example 4

Other than changing the temperature inside the supporting tank 31 to 250° C., the Pd-particles-supporting carrier was obtained in the same manner as Example 1.

FIG. 6 shows an SEM photograph of the Pd-particles-supporting carrier.

### Example 5

Other than changing the temperature inside the supporting tank 31 to 300° C., the Pd-particles-supporting carrier was obtained in the same manner as Example 1.

### Example 6

Other than raising the pressure inside the system to 25 MPa, the Pd-particles-supporting carrier was obtained in the same manner as Example 1.

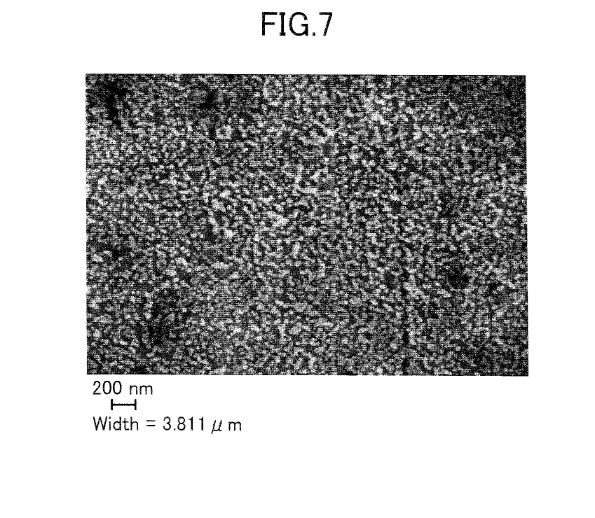

FIG. 7 shows an SEM photograph of the Pd-particles-supporting carrier.

### Example 7

Other than raising the pressure inside the system to 30 MPa, the Pd-particles-supporting carrier was obtained in the same manner as Example 1.

### Example 8

Other than supplying the Pd(acac)₂ dissolved in the supercritical carbon dioxide to the supporting tank 31 for five hours, the Pd-particles-supporting carrier was obtained in the same manner as Example 1.

### Example 9

Other than supplying the Pd(acac)₂ dissolved in the supercritical carbon dioxide to the supporting tank 31 by 0.5 mL per minute, the Pd-particles-supporting carrier was obtained in the same manner as Example 1.

### Example 10

Other than supplying the Pd(acac)₂ dissolved in the supercritical carbon dioxide to the supporting tank 31 by 1.0 mL per minute, the Pd-particles-supporting carrier was obtained in the same manner as Example 1.

### Example 11

Other than using mesoporous silica as the carrier, the Pd-particles-supporting carrier was obtained in the same manner as Example 1.

It was confirmed from FIGS. 5 through 7 that the particle size of the Pd particles according to Examples 1, 4, and 6 could be controlled by changing the temperature and the pressure inside the supporting tank 31. Further, it was confirmed that the Pd particles according to Examples 1, 4, and 6 were supported on the carrier without being greatly secondarily-aggregated.

Note that it was also confirmed that the particle size of the Pd particles other than Examples 1, 4, and 6 could be controlled and the Pd particles were supported on the carrier without being greatly secondarily-aggregated.

The present application is based on Japanese Priority Applications Nos. 2009-258346 filed on Nov. 11, 2009, and 2010-198130 filed on Sep. 3, 2010 with the Japan Patent Office, the entire contents of which are hereby incorporated by reference.

1. A method for producing a catalyst-supporting carrier, the method comprising:
supplying subcritical carbon dioxide or supercritical carbon dioxide to a dissolving tank containing a catalyst precursor generated when a catalyst is reduced to dissolve the catalyst precursor in the subcritical carbon dioxide or the supercritical carbon dioxide, to generate a dissolved catalystprecursor;
supplying the dissolved catalyst precursor to a supporting tank containing a carrier;
reducing the dissolved catalyst precursor to form a catalyst-supported carrier; and
supplying additional subcritical carbon dioxide or supercritical carbon dioxide to the supporting tank to clean the catalyst-supported carrier.

2. The method of claim 1, further comprising:
oxidizing the cleaned catalyst-supported carrier.

3. The method of claim 1, wherein
the catalyst precursor is thermally reduced.

4. The method of claim 1, wherein
the catalyst precursor is a metal complex or metal alkoxide.

5. The method of claim 1, wherein
the catalyst is at least one selected from the group consisting of gold, copper, silver, platinum, iron, palladium, ruthenium, rhodium, tungsten, nickel, tantalum, bismuth, tin, zinc, titanium, aluminum, manganese, cobalt, iridium, osmium, molybdenum, chromium, and vanadium.

6. The method of claim 1, wherein
the carrier is a honeycomb structure.

7. An apparatus for producing a catalyst-supporting carrier, the apparatus comprising:
a dissolving tank in which a catalyst precursor generated when a catalyst is reduced is dissolved in subcritical carbon dioxide or supercritical carbon dioxide;
a supplying unit that supplies the subcritical carbon dioxide or the supercritical carbon dioxide to the dissolving tank;
a supporting tank in which the catalyst precursor dissolved in the subcritical carbon dioxide or the supercritical carbon dioxide is reduced to form a catalyst-supported carrier; and
a cleaning unit that supplies the subcritical carbon dioxide or the supercritical carbon dioxide to the supporting tank to clean the catalyst-supported carrier.

8. The apparatus of claim 7, wherein
the supplying unit serves as the cleaning unit and bypasses the dissolving tank to supply the subcritical carbon dioxide or the supercritical carbon dioxide to the supporting tank.

9. The apparatus of claim 7, wherein
the supporting tank comprises a heating unit that thermally reduces the dissolved catalyst precursor.

10. The method of claim 2, wherein
the catalyst precursor is thermally reduced.

11. The method of claim 2, wherein
the catalyst precursor is a metal complex or metal alkoxide.

12. The method of claim 3, wherein
the catalyst precursor is a metal complex or metal alkoxide.

13. The method of claim 2, wherein
the catalyst is at least one selected from the group consisting of gold, copper, silver, platinum, iron, palladium, ruthenium, rhodium, tungsten, nickel, tantalum, bismuth, tin, zinc, titanium, aluminum, manganese, cobalt, iridium, osmium, molybdenum, chromium, and vanadium.

14. The method of claim 3, wherein
the catalyst is at least one selected from the group consisting of gold, copper, silver, platinum, iron, palladium, ruthenium, rhodium, tungsten, nickel, tantalum, bismuth, tin, zinc, titanium, aluminum, manganese, cobalt, iridium, osmium, molybdenum, chromium, and vanadium.

15. The method of claim 2, wherein
the carrier is a honeycomb structure.

16. The method of claim 3, wherein
the carrier is a honeycomb structure.

17. The method of claim 1, comprising:
supplying subcritical carbon dioxide to a dissolving tank containing a catalyst precursor generated when a catalyst is reduced to dissolve the catalyst precursor in the subcritical carbon dioxide, to generate a dissolved catalyst precursor;
supplying the dissolved catalyst precursor to a supporting tank containing a carrier;
reducing the dissolved catalyst precursor to form a catalyst-supported carrier; and
supplying additional subcritical carbon dioxide to the supporting tank to clean the catalyst-supported carrier.

18. The method of claim 1, comprising:
supplying supercritical carbon dioxide to a dissolving tank containing a catalyst precursor generated when a catalyst is reduced to dissolve the catalyst precursor in the supercritical carbon dioxide, to generate a dissolved catalyst precursor;
supplying the dissolved catalyst precursor to a supporting tank containing a carrier;
reducing the dissolved catalyst precursor to form a catalyst-supported carrier; and
supplying additional supercritical carbon dioxide to the supporting tank to clean the catalyst-supported carrier.

19. The apparatus of claim 7, comprising:
a dissolving tank in which a catalyst precursor generated when a catalyst is reduced is dissolved in subcritical carbon dioxide;
a supplying unit that supplies the subcritical carbon dioxide to the dissolving tank;
a supporting tank in which the catalyst precursor dissolved in the subcritical carbon dioxide is reduced to form a catalyst-supported carrier; and
a cleaning unit that supplies the subcritical carbon dioxide to the supporting tank to clean the catalyst-supported carrier.

20. The apparatus of claim 7, comprising:
a dissolving tank in which a catalyst precursor generated when a catalyst is reduced is dissolved in supercritical carbon dioxide;
a supplying unit that supplies the supercritical carbon dioxide to the dissolving tank;
a supporting tank in which the catalyst precursor dissolved in the supercritical carbon dioxide is reduced to form a catalyst-supported carrier; and
a cleaning unit that supplies the supercritical carbon dioxide to the supporting tank to clean the catalyst-supported carrier.
